(19) United States
(12) Patent Application Publication
(10) Pub. No.: US 2008/0027846 A1
(43) Pub. Date: Jan. 31, 2008

(54) SUBSTANTIAL EQUITY CONTENT TRUST PREFERRED ("SECTRS")

(76) Inventors: Sean Brady, New York, NY (US); Mark Tristram, London (GB); Louis Feldman, Livingston, NJ (US); Salvatore Seguna, New York, NY (US)

Correspondence Address: BAKER BOTTS L.L.P., 30 ROCKEFELLER PLAZA, 44TH FLOOR, NEW YORK, NY, 10112-4498, US

(21) Appl. No.: 11/619,146

(22) Filed: Jan. 2, 2007

Related U.S. Application Data
(60) Provisional application No. 60/755,271, filed on Dec. 30, 2005.

(51) Int. Cl. G06Q 40/00

(52) U.S. Cl. 705/36 R

(57) ABSTRACT

A hybrid financial instrument, based on the traditional trust proffered structure, is designed to be more equity-like than debt-like. The financial instrument is designed to have permanence, ongoing payments, and loss absorption characteristics that meet rating agency requirements for favorable equity-like treatment.

### BACKGROUND OF THE INVENTION

Investors desire tax-advantaged investing in stocks, bonds, real estate, commodities or any other asset, for obvious reasons. Similarly, companies like to raise capital in a tax-advantaged manner. The responsive financial industry has come forth with hybrid financial instruments, which are designed to confer tax advantages to investors/companies by either deferring taxes on the income or by structuring the financial instruments so that the immediate tax or high tax-liability components of the financial instruments are stripped and reassigned or reallocated to other willing counter parties. Similarly, hybrid financial instruments may be structured to provide tax and/or market price advantage to issuing companies seeking to raise capital or funds.

The tax or market price advantages of these hybrid financial instruments are interlinked with the statutory income tax codes and/or financial market rules under which different types of income or assets, and different types of investors and/or companies, are assessed.

Trust preferred securities are an example of hybrid financial instruments structured for tax-advantaged investing. The trust preferred is a hybrid security consisting of a preferred stock issued by a special trust and a debt security issued by a company. The special trust is a subsidiary of the company set up solely for the purpose of selling and administering the trust preferred securities. The trust sells their preferred securities to investors and then uses the proceeds from the sale of the trust preferred securities to buy debt securities (debentures, etc.) from the company setting up the trust. The debt securities are generally junior subordinated deferrable interest debentures, which are the lowest ranked of the debt securities issued by the company, and which generally have a maturity date of 30 to 80 years from the date of issue. The interest payments of the debt securities, paid by the company to the trust, are used to fund the trust's distributions to the preferred security holders. When the debt securities mature and are paid off, the trust in turn uses those funds to pay off the trust preferred securities that mature on the same date as the debt securities. Trust preferred can be redeemed (called) at the company's option, generally at the issue price (liquidation preference), and generally on or after five years from the date of issue. Redemption of the securities, on or after the specified optional redemption date, is optional for the company but, if called, the call for redemption is mandatory for the holder of the securities. The debt securities generally have a deferrable interest clause that allows the company to defer distributions for up to five years at their option and for any reason but not beyond the maturity date. A distribution deferral will generate a very unpleasant situation for the preferred holder as the tax laws require the holder to pay taxes on the deferred but accruing dividends even though the holders is not receiving any cash. The company also provides a rather limited guarantee for the trust preferred that guarantees that, if the company pays the interest payment to the trust, the company guarantees that the trust will pay the dividend payments to the security holders. The advantage of this hybrid arrangement to the company is that the interest paid on the debt securities is deductible from their income taxes while normal preferred dividends would not be deductible.

Another example of a hybrid financial instrument structured for tax-advantaged investing is the security offered by Lehman Brothers under the name Enhanced Capital Advantaged Preferred Securities (ECAPS), which is designed to be more-equity like which is considered to be more desirable than debt on the issuing company's books by rating agencies. There are a few key differences between ECAPS and trust preferred. ECAPS have a 60-year maturity, twice as long as the typical trust preferred. They also have mandatory deferral features, the key one being that if a pre-specified trigger is reached, the issuer is required immediately to issue either common stock or certain qualifying perpetual preferred stock to fund the distribution to ECAPS holders. By contrast, the deferral mechanism on trust preferred is not mandatory, nor is there an equity issuance requirement. Finally, the deferral period on ECAPS is up to 12 years compared with the five on a traditional trust preferred.

Credit rating agencies have recognized that hybrid securities such as ECAPS are more equity-like. For example, Moody's, assigns zero equity credit to trust preferred. ECAPS, however, receive 75% equity credit and 25% debt. The picture is similar at Standard & Poor's, where financial companies currently receive 100% equity credit for trust preferred, which can account for up to 10% of total adjusted equity. ECAPSs qualify to receive 100% equity credit up to 15% of total adjusted equity.

Equity-like hybrid securities such as the ECAPS have recognized disadvantages and inefficiencies, for example:

Complexity: Departing from traditional trust preferred, ECAPS utilizes both a trust and an LLC, adding a layer of complexity

Inefficiency: For tax purposes, 5% of the ECAPS LLC capital is invested in assets other than the issuer debt.

Tax treatment: ECAPS requires two separate tax conclusions:
deductibility of interest on the debentures,
characterization of the LLC as a partnership for tax purposes.

Dilution: ECAPS obligates the issuer to issue equity to fund full LLC distributions in the event of mandatory deferral, leading to dilution risk.

In general, the rating agencies have established methodologies for allocating equity credit for hybrid securities. For example, Moody's methodology highlights three key components of a hybrid security related to equity—Permanence, No ongoing payments, and Loss absorption. Each of the three key components are rated (e.g., as “None”, “Weak”. “Moderate”, or “Strong”) in order to determine the corresponding equity credit treatment (basket) that the security receives. Depending on the ratings of the three key components, Moody's places a security in equity credit Baskets A-E along a debt-like to equity-like continuum, with Baskets A-E corresponding to 0%, 25%, 50%, 75% and 100% equity-like credit treatment, respectively.

Consideration is now being given to structuring hybrid securities to be more equity-like with a view to avoid complexity, minimize risk and improve tax efficiency. In particular, attention is being directed to structuring hybrid securities to qualify for at least Moody's Basket C or Basket D equity credit treatments.

### BRIEF DESCRIPTION OF THE DRAWINGS

The features, nature, objects, and various advantages of the present invention will become more apparent from the following detailed description and the accompanying drawings, wherein like reference characters represent like elements throughout, and in which:

FIG. 1 is a schematic illustration of the components and operation of a hybrid financial instrument designed to be more equity-like than debt-like, in accordance with the principles of the present invention.

FIG. 2 is a schematic illustration of various configurations of the structural components of hybrid securities that qualify for at least Basket C or Basket D equity-like treatment, in accordance with the principles of the present invention.

### DETAILED DESCRIPTION OF THE INVENTION

Equity-like hybrid financial instruments are provided. The hybrid financial instruments, which are structured along the lines of a trust preferred, are referred to herein as the “Substantial Equity Content Trust Preferred (“SECTRS”). SECTRS provides the issuing parties with choices for diversity, simplicity, flexibility, liquidity, ease of trading, risk management, and tax efficiency, in capital structure and organization.

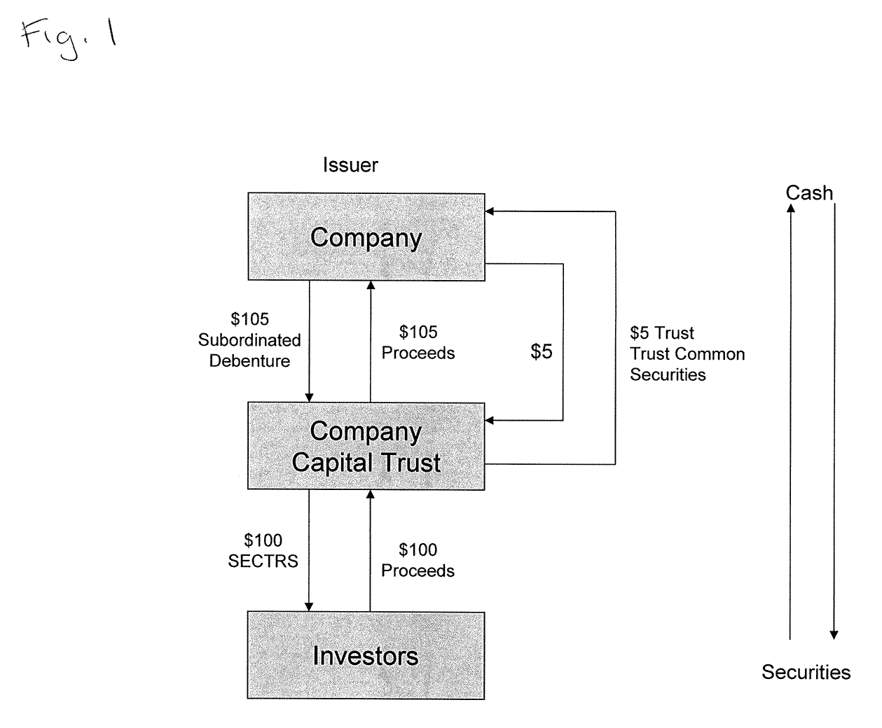

A SECTRS instrument is based on a traditional tax-deductible trust preferred security. FIG. 1 shows a block diagram of the components and operation of an exemplary SECTRS. Three parties are involved in the operation of SECTRS, namely the Issuer 100, a Company Capital Trust 200 and Investors 300. Like the traditional trust preferred, the operation of the SECTRS has three components:

1. A junior subordinated debenture 10 issued to Company Capital Trust 200 by Issuer 100.

2. Preferred trust interests (“SECTRS”) 30 sold to Investors 300.

3. A small amount of common capitalization 20 of Company Capital Trust 200

SECTRS is designed to enhance a traditional trust preferred to meet Moody's three key requirements (i.e., Permanence, Ongoing Payments and Loss Absorption) for at least Basket C (50% equity) or Basket D (75% equity) treatment without sacrificing tax deductibility.

An exemplary “Basket D” SECTRS is structured for permanence, for example, by having a 60-year final maturity term. The exemplary SECTRS is structured to have an optional cash call from 5 or 10 years, with capital replacement language. A 100 bps step-up may or may not be included at the time of the first optional call date.

Further, with respect to the Ongoing Payments requirement for favorable Moody ratings, the exemplary “Basket D” SECTRS is structured to include optional dividend deferral on cumulative basis. Some versions of SECTRS may also include mandatory dividend deferral based on objective triggers. An issuers who does not wish to be subject to mandatory dividend deferral triggers may opt to issue “Basket C” SECTRS with standard optional deferral features or “Basket D” SECTRS with strengthened optional deferral features.

With respect to the Loss Absorption requirement for favorable equity-like Moody ratings, the SECTRS, like the traditional trust preferred, rank junior subordinated to all creditors, except trade payables.

In operation, the exemplary SECTRS may be structured to have the following characteristics:
Optional Coupon Deferral: The Issuer may be given full discretion to defer dividends on a cumulative basis for up to 10 years or other such term. A common stock dividend stopper applies as long as SECTRS dividends are deferred. The Issuer must settle all deferred coupons via an Alternative Payment Mechanism (the “APM”), which requires deferred coupons be settled with proceeds raised from the sale of equity (subject to certain caps), for example, upon the earlier of the following exemplary events:
   The Issuer has deferred coupons for more than 5 years; and
   The Issuer resumes current distributions.
Mandatory Deferral: Mandatory deferral may be set to occur for up to 10 years if the Issuer trips pre-determined financial triggers. In a mandatory deferral event, the Issuer is required to immediately use commercially reasonable efforts to issue common or perpetual preferred equity and use the proceeds to settle the mandatory deferred dividends.
Maturity: SECTRS may be set up as long term instruments (e.g., 60-year instruments), callable with or without a step-up, for example, from 5/10/30 years. The debentures issued to the trust may have a 30-year final maturity. If the SECTRS have not been called before 30 years, the debentures may be rolled over for another 30 years, at an interest rate that is no higher than the stepped-up rate. Alternatively, the debentures may be a 60 year instrument, a 60 year instrument extendable for up to an additional 20 years, an 80 year instrument, or an instrument having any such suitable term.
Accounting and Tax: The accounting and tax treatment for SECTRS may be expected to be the same as trust preferred.

The inventive financial instruments (i.e. SECTRS), unlike other purported equity-like instrument (e.g., ECAPS) avoid complexity by utilizing only one intermediate entity (i.e. Company Capital Trust) in the same manner as a traditional trust preferred. No additional partnership complexity is required. The SECTR is advantageously expected to benefit from a “will” tax opinion and specifically designed to minimize dilution/registration issues in the event of a mandatory trigger event.

The mandatory deferral provisions of SECTRS lead to its Moody's Basket D treatment qualification.

The mandatory deferral provisions in a hybrid security are invoked when the pre-determined objective financial triggers (e.g., based on profitability, leverage ratios) are breached. If a trigger is breached, the issuer is required to sell preferred and/or common stock in order to fund coupons, unless a market disruption event is occurring. As long as any deferred coupons are outstanding, the issuer is prevented from paying dividends on or redeeming its common stock. Such mandatory deferral provisions permit a ‘Strong' ranking in Moody's evaluation of the ‘No Ongoing Payments’ component of the hybrid security. With mandatory triggers, an issuer only needs to provide intent-based replacement language to obtain Basket D equity-like treatment for its hybrid security.

An alternative to a mandatory deferral provision in a hybrid security for qualifying for Basket D equity-like treatment is a ‘Strong Optional Deferral’ provision with ‘Capital Replacement Covenant’ provision. The strong optional deferral provision requires that optionally deferred interest amounts be funded with equity sales. The Strong Optional Deferral provision coupled with a Replacement Capital Covenant provision permits a Moderate ranking in Moody's evaluation of the ‘No Ongoing Payments’ component of the hybrid security.

Further, in accordance with the present invention, the hybrid security may be structured to provide convenient financing alternatives to the strong optional deferral provision requirement that optionally deferred interest amounts be funded with equity sales. Such funding of deferred interest amounts with equity sales hinders an issuer's financial flexibility because the need arises at times that are unfavorable to access the equity capital markets (e.g., when the issuer's stock price is likely to be depressed after the issuer resumes current payments following a period of deferral).

One such convenient financing alternative is an interest capitalization feature, which effectively increases the outstanding principal amount of the SECTRS instrument. The interest capitalization feature may be an alternate to any APM provisions in the SECTRS instrument. The interest capitalization feature allows the issuer to capitalize, for example, up to two years' of deferred coupons. The issuer is not required to sell equity to pay deferred interest that has been capitalized. Further, the capitalized coupons need not be paid until a later date (e.g., final maturity/redemption of the hybrid security), and there may be no ongoing dividend stopper as a result of capitalized coupons remaining outstanding. This capitalization option provides the issuer with increased flexibility during short-term interest deferral scenarios.

This interest capitalization feature can be beneficial to an issuer at least during the short deferral scenarios (e.g., lasting two years or less). By electing to capitalize deferred coupons, an issuer is able to resume current hybrid coupons and common dividends without having to access the equity capital markets in adverse circumstances.

The interest capitalization feature strengthens the equity-like characteristics of the security by allowing the issuer to avoid having to sell additional equity to meet the optionally deferred coupon payments at least in certain limited circumstances. Such limited optional deferrals features may be referred to hereinafter as “Strong Optional Deferral” features. A security having only an optional deferral feature, but not a mandatory deferral feature, usually can qualify only for Basket C treatment. In contrast, a SECTRS instrument, which includes the Strong Optional Deferral features, may omit the mandatory deferral feature and yet qualify for Basket D treatment.

It will be understood that SECTRS instruments with a mandatory deferral feature and the strong optional deferral feature described above are only illustrative embodiments of the inventive hybrid security structures designed to achieve desirebable Moody's equity-like treatment. In practice, various modifications can be made by those skilled in the art to the particular embodiments without departing from the scope and spirit of the disclosed subject matter as defined by the appended claims. Features of the illustrative embodiments may be combined with other illustrative embodiments, modified, or omitted to create new embodiments.

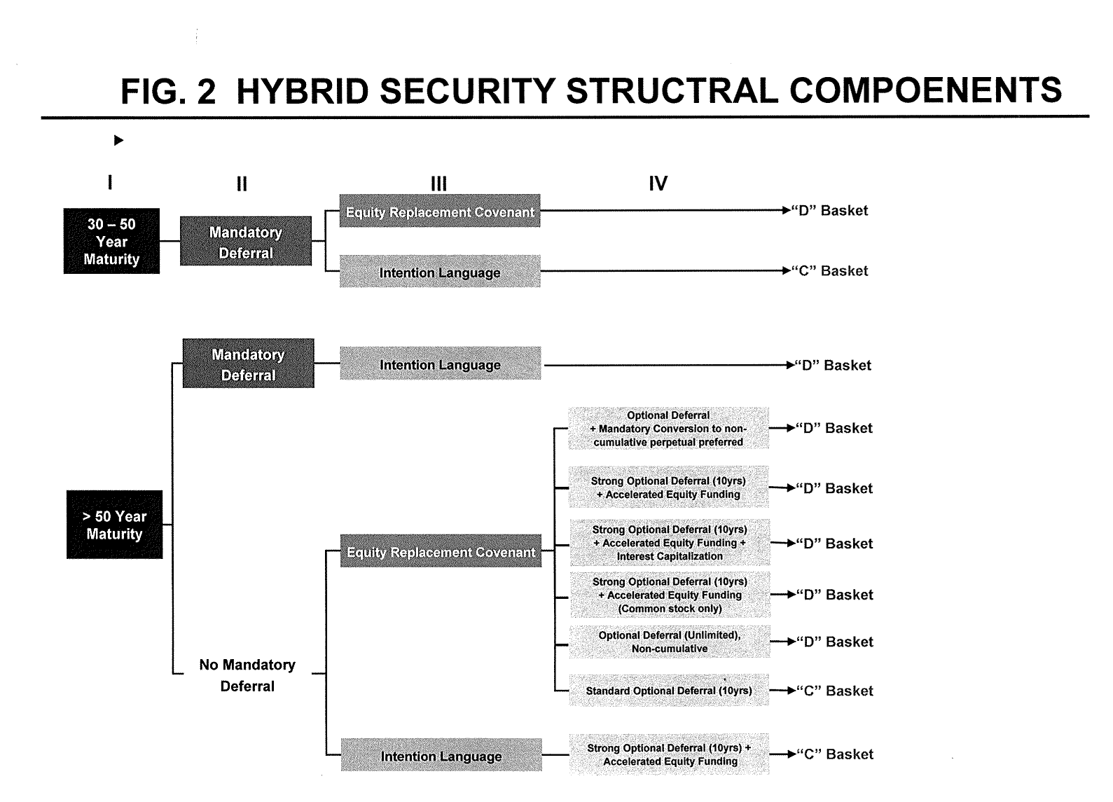

FIG. 2 shows, for example, key components of hybrid security structures (i.e., term, mandatory or optional deferral provisions, equity replacement covenants or intention provisions) in various alternative configurations leading to Moody's Basket D or C treatments. In particular, the “strong optional deferral” components that lead to Moody's Basket D treatment may be (1) Mandatory Conversion to non-cumulative perpetual preferred feature, (2) Strong Optional Deferral (10 yrs) with a Accelerated Equity Funding feature, (3) Strong Optional Deferral (10 yrs) with Accelerated Equity Funding and Interest Capitalization features (e.g., IC_SECTRS), (4) Strong Optional Deferral (10 yrs) with Accelerated Equity Funding by common stock only, or (5) a non-cumulative Optional Deferral (unlimited) feature, etc.

Further, the hybrid securities described herein may be modified to have different configurations of parties or counterparties involved in the structure, in accordance with the principles of the present invention. For example, with reference to FIG. 1, intermediate trust 200 may be necessary only for financial issues to get the proper regulatory treatment. Thus for non-financial issues, or wherever appropriate, a debt instrument having a structure like the SECTRS, may be issued from the company 100 directly to investors 300.

It will be understood that the foregoing is only illustrative of the principles of the invention and that various modifications can be made by those skilled in the art without departing from the scope and spirit of the invention.

1. A financial instrument comprising:
a junior subordinated debenture issued by a company to a trust;
a capitalization of the trust in an amount which is a fraction of the junior subordinated debenture amount; and
preferred trust interests (“SECTRS”) that are made available to investors, wherein the preferred trust interests represent the difference in the amount of the junior subordinated debenture and the amount of capitalization of the trust.

2. The financial instrument of claim 1 wherein the preferred trust interests comprise:
a maturity term of about 60 years;
an option to call with a step-up at a predefined time; and
a predefined number of basis points (bps) at step-up.

3. The financial instrument of claim 1 wherein the preferred trust interests comprise:
a provision for mandatory dividend deferral upon occurrence of a mandatory deferral event, which is predefined on objective criteria; and
a provision for reducing dividends during the mandatory deferral period.

4. The financial instrument of claim 1 wherein the preferred trust interests comprise:
a provision for optional dividend deferral at the discretion of the issuer on a cumulative basis over a predefined deferral period; and
a provision for funding of deferred and current dividends with the issuer's equity within a limited time period after the end of the predefined deferral period.

5. The financial instrument of claim 6 further comprising a provision for a dividend stopper on issuer's common stock during periods of optional dividend deferral on the preferred trust interests.

6. The financial instrument of claim 1 wherein the preferred trust interests comprise:
a provision for optional dividend deferral at the discretion of the issuer on a cumulative basis over a predefined deferral period; and
a provision for capitalization of the deferred dividend amounts during a predefined capitalization time period.

7. The financial instrument of claim 6 wherein the preferred trust interests further comprise:
a provision for deferring payments of capitalized dividends to a date later than the predefined capitalization time period.

8. The financial instrument of claim 7 wherein the preferred trust interests further comprise:
a provision for resuming current dividend payments at the end of the predefined capitalization time period.

9. The financial instrument of claim 6 further comprising:
a provision allowing normal dividend payments on issuer's common stock during the predefined capitalization time period.

10. A method for funding a company, the method comprising:
issuing a junior subordinated debenture to a trust;
capitalizing the trust in an amount which a fraction of the junior subordinated debenture amount; and
selling preferred trust interests (“SECTRS”) to investors, wherein the preferred trust interests represent the difference in the amount of the junior subordinated debenture and the amount of capitalization of the trust.

11. The method of claim 10, wherein selling preferred trust interests comprises selling preferred trust interests having:
a maturity term of about 60 years;
an option to call with a step-up at a predefined time; and
a predefined number of basis points (bps) at step-up.

12. The method of claim 10, wherein selling preferred trust interests comprises selling preferred trust interests having:
a provision for mandatory dividend deferral upon occurrence of a mandatory deferral event, which is predefined on objective criteria; and
a provision for reducing dividends during the mandatory deferral period.

13. The method of claim 10, wherein selling preferred trust interests comprises selling preferred trust interests having:
a provision for optional dividend deferral at the discretion of the issuer on a cumulative basis over a predefined deferral period; and
a provision for funding of deferred and current dividends with the issuer's equity within a limited time period after the end of the predefined deferral period.

14. The method of claim 10, wherein selling preferred trust interests comprises selling preferred trust interests having:
a provision for a dividend stopper on issuer's common stock during periods of optional dividend deferral on the preferred trust interests.

15. The method of claim 10, wherein selling preferred trust interests comprises selling preferred trust interests having:
a provision for optional dividend deferral at the discretion of the issuer on a cumulative basis over a predefined deferral period; and
a provision for capitalization of the deferred dividend amounts during a predefined capitalization time period.

16. The method of claim 15, wherein selling preferred trust interests comprises selling preferred trust interests having:
a provision for deferring payments of capitalized dividends to a date later than the predefined capitalization time period.

17. The method of claim 16, wherein selling preferred trust interests comprises selling preferred trust interests having:
a provision for resuming current dividend payments at the end of the predefined capitalization time period.

18. The method of claim 15, wherein selling preferred trust interests comprises selling preferred trust interests having:
a provision for resuming current dividend payments at the end of the predefined capitalization time period.
